(19) United States
(12) Patent Application Publication
(10) Pub. No.: US 2008/0121122 A1
(43) Pub. Date: May 29, 2008

(54) Calender Unit for Producing and/or Processing Thin Films

(76) Inventors: Klaus Kubik, Toenisvorst (DE); Bernhard Funger, Krefeld (DE)

Correspondence Address: KENYON & KENYON LLP, ONE BROADWAY, NEW YORK, NY, 10004, US

(21) Appl. No.: 11/793,700

(22) PCT Filed: Dec. 2, 2005
(86) PCT No.: PCT/EP05/12888

§ 371 Date: Jan. 3, 2008

(30) Foreign Application Priority Data
Dec. 20, 2004 (DE) 20 2004 019 602.6

(51) Int. Cl. D21G 1/00; B29C 43/46; D21G 1/02; F16C 13/00; B30B 3/04

(52) U.S. Cl. 100/336; 492/6; 100/335

(57) ABSTRACT

A calender unit for producing and/or processing thin films, includes two rollers that are rotatably supported at two bearing points in a frame, which each include a hollow cylindrical roller body that forms the working roller circumference, the two roller circumferences forming a roller gap between themselves and at least the one roller is arranged so that it is able to be cooled using a heat exchange medium, the roller body of this roller being arranged as a hollow cylinder and the roller including a carrier which protrudes at one end from the roller body and is supported torsionally fixed on the frame as well as in the roller body to allow a rotation of same about the roller axis, the support of the crosshead taking place in the roller body between the two bearing points, as seen in the longitudinal direction, and device(s) being provided for reducing profile errors in the operation of the calender unit.

### FIELD OF THE INVENTION

The present invention relates to a calender unit for producing and/or processing thin films.

### BACKGROUND INFORMATION

For the production of plastic films, it is conventional that one may supply the extruded, free-flowing plastic molding material to a working gap formed by the working circumferences of two rollers, using a sheeting die.

At least one of the roller jackets of the two rollers is cooled, in this connection, so that the pasty plastic molding material is formed to a film while running through the roller gap and is solidified by sufficient heat loss. The roller gap determines the thickness of the exiting film, in this instance.

In order to increase production rates, the trend in such film calender units is towards longer roller lengths, so that one can produce wider film webs in this manner.

Beyond that, film materials are being developed having increasingly greater hardnesses.

The result of the above trends is that the roller jackets bordering on the roller gap increasingly tend to deformations during the production process and the processing process of the film. In this connection, on the one hand, bending stresses of both rollers may occur to the effect that the rollers bend away from each other in their middle range, so that a calendered film, after running through the roller gap, has a greater thickness in the middle than at the edge. If the bending line of the roller has a curve deviating from a parabola, in this context, it shall be referred to as a bending line error. In addition, if the working circumference of the rollers is formed by thin-walled roller jackets, shell deformation is liable to occur, that is, deviation of the cross section of the roller from the circular form, in the region of the roller gap. This deformation can also negatively influence the production process and the processing process, since the roller gap, on the side of the deformed roller, is no longer linearly bordered but rather in a planar manner. The profile error of the calender unit is the result of all the errors and deformations, during production and/or processing, that enter into the film.

A calender unit for the production and/or processing of thin films is described in German Published Patent Application No. 20 2004 010 222, in which the rollers bordering on the roller gap each have a rotatably supported axis. A double jacket that is supported in a torsionally fixed manner and is able to have an heat exchange medium flow through it is provided on this axis. The double jacket includes an inner jacket, an inner supporting structure mounted on the outside of that, and an outer jacket, mounted on the supporting structure, whose outer circumference forms the working circumference of the respective roller.

In order to avoid the bending apart of the two rollers in the middle region, the inner jacket is supported on the axis centrically between the outer edge regions of the axis, and the outer jacket is formed such that, at the outer edge regions between the axis and the double jacket, a circumferentially circular gap is provided in the unloaded state.

This is intended to achieve that the middle of the roller is not the place having the largest gap deviation, but rather the place having the smallest gap deviation in response to centrical support, or at least a greatly reduced gap deviation compared to usual rollers.

In the case of this calender unit, a correction of the profile error is possible only for a limited line force region prevailing in the roller gap during production and/or processing of the film, since outside of this region a compensatory deflection by the axis and the double jacket of each roller, in the sense of a constant roller gap over this length, is not ensured because of the different bending characteristics. Furthermore, a calender unit having such rollers is very costly to manufacture, because of the roller construction.

### SUMMARY

Example embodiments of the present invention provide a calender unit for producing and/or processing thin films, also referred to as a “film calender unit”, in which the profile error is reduced and which is at once suitable for generating line forces in the roller gap in a large force region, without having an intolerable profile error occur.

According to example embodiments of the present invention, a film calender unit includes two rollers supported rotatably on a frame, which each include cylindrical roller elements that form the working roller circumference, the two roller circumferences forming a roller gap between themselves. At least one roller is configured such that its roller body is able to be cooled using a heat exchange medium, in order thus to make certain the solidifying of the film as it passes through the roller gap and the fixing of the film. The roller body of this roller is also arranged as a hollow cylinder and includes a carrier which protrudes at one end from the roller body and is supported torsionally fixed on the frame, as well as supported rotatably on a crosshead in the roller body, permitting rotation of the latter about the roller axis. The supporting on the crosshead takes place between the two support locations of the roller on the frame, as seen in the longitudinal direction. Because of this measure, the roll is distinguished by a particularly compact arrangement, as is required for its use in film calender units. Based on the support of the crosshead in the roller jacket in the longitudinal direction, at a distance from the support of the roller in the frame, the roller gap has an M profile under load, under the assumption that the counter roller does not undergo deformation, as is illustrated in an example in FIG. 1. In order to counteract the formation of this undesired profile, the roller also has a device for correcting profile errors occurring during the operation of the calender unit.

Using a roller designed in that fashion, line forces, that are to be expected in film calender units, can be generated with a minimum of profile errors in the roller gap.

The connecting device for supplying and removing the heat exchange medium may be situated at that end region of the roller which is opposite to the end at which the crosshead protrudes from the roller body. This measure realizes an especially compact arrangement of the roller.

The device for correcting the profile error can have at least one pressure chamber provided at the crosshead, into which a pressure medium is able to be introduced, which acts, using at least one force component, in the effective plane subtended by the two roller axes, towards the roller gap from the inside onto the roller body. This measure, described, e.g., in German Published Patent Application No. 1 243 965, from non-cooled rollers used for a different purpose, leads to a reduction in the deformation of the roller body. Profile errors conditioned upon shell deformation and/or bending line errors of the roller(s) cannot be reduced by this roller. But this is not necessary either because it includes a rubber jacket which reduces the effects of these profile errors.

A device for varying the pressure in the roller longitudinal direction may be provided in the pressure chamber. This refinement may be of advantage especially if rollers are involved in which an especially large bending line error is to be expected. The rollers may have a length of >140 cm.

The device for correcting the bending line errors can include a plurality of hydraulic support elements acting on the inner circumference of the roller jacket that are situated in the longitudinal direction of the roller, as are described, for instance, in European Published Patent Application No. 0 772 715.

The foregoing may be sufficient, for achieving a sufficiently constant width of the processing gap, over the length of the roller, optionally to apply two different pressures to the supporting elements. The higher pressure is applied to those support elements that are situated referred to the longitudinal direction of the roller gap in which the film has a greater thickness after production and processing.

At least one of the rollers may include a device for correcting the bending line errors in the edge regions, that acts thermally or mechanically on the edge regions of the roller jacket.

At least one roller may include peripheral bores for passing through the heat carrier medium. The dissipation of the heat closely below the surface of the roller jacket, which is given off by the film to the roller, has the result that the heating up of the roller jacket is limited, which counteracts the formation of thermally induced concentricity errors.

In order to simplify the mounting and maintenance of the one roller, it may be arranged in several parts such that the crosshead can be optionally removed from the roller body and can be reinserted. In constructional terms, this measure can be effected in that at least one flange, that can be screwed down, that forms the neck of the roll, is provided at the ends of the hollow cylinder roller body which, after being unscrewed, frees the entire internal cross section of the roller body.

For the further reduction of the profile error, at least one of the two rollers can include a corrective grinding so as to reduce the bending line error. If the calendered film has, for example, the thickness profile illustrated in FIG. 1 over its width, the edge regions and the middle region of at least one of the two rollers may be ground so as to produce a diameter reduction.

In addition, it is possible to achieve a further correction in the profile error in which the resilience of the other roller is adapted to the bending line curve of the one roller.

In a constructional manner, this can be put into effect in that the wall thickness of the roller jacket is reduced at places at which the film demonstrates a reduced thickness (edge region and middle region in FIG. 1).

The roller circumference of the roller jacket can be hardened in order to increase resistance to wear of the roller. It may be furnished, for instance, with a chrome layer to reduce surface roughness.

In order to be able to adjust the calender unit to different production and processing requirements, a device may be provided for adjusting the roller gap.

This device may have longitudinal adjusters that act between the support locations of the two rollers.

These longitudinal adjusters can include in each case at least two wedge elements of which at least one is displaceable transversely to the roller axes.

A possible thickness profile of a film, as well as an exemplary embodiment of a calender unit are schematically illustrated in the drawings.

### BRIEF DESCRIPTION OF THE DRAWINGS

FIG. 1 illustrates the thickness profile of a film transversely to the running direction at insufficient correction of the bending line error, the film thickness being shown vertically and the film width horizontally.

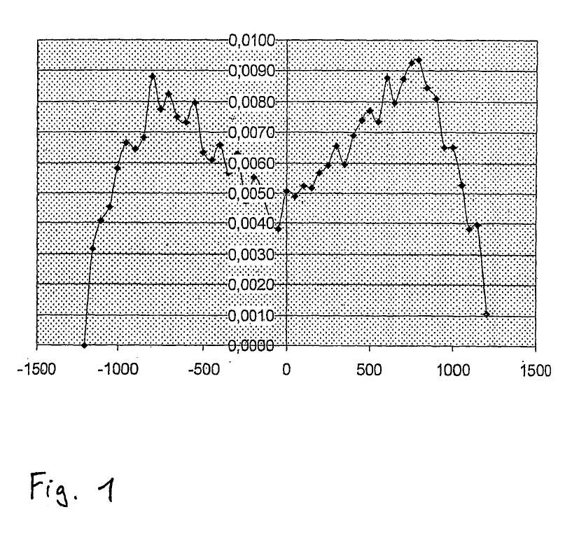

FIG. 2 illustrates a roller pair of a calender unit according to an example embodiment of the present invention, in longitudinal section.

FIG. 3 illustrates the same roller pair in a view of the cross section III-III in FIG. 2.

FIG. 4 illustrates a pair of rollers of a calender according to an example embodiment of the present invention in an illustration corresponding to that of FIG. 2.

FIG. 5 illustrates the same pair of rollers in an illustration corresponding to that of FIG. 3.

FIG. 6 illustrates a pair of rollers of a calender unit according to an example embodiment of the present invention in an illustration corresponding to that of FIGS. 2 and 4.

### DETAILED DESCRIPTION

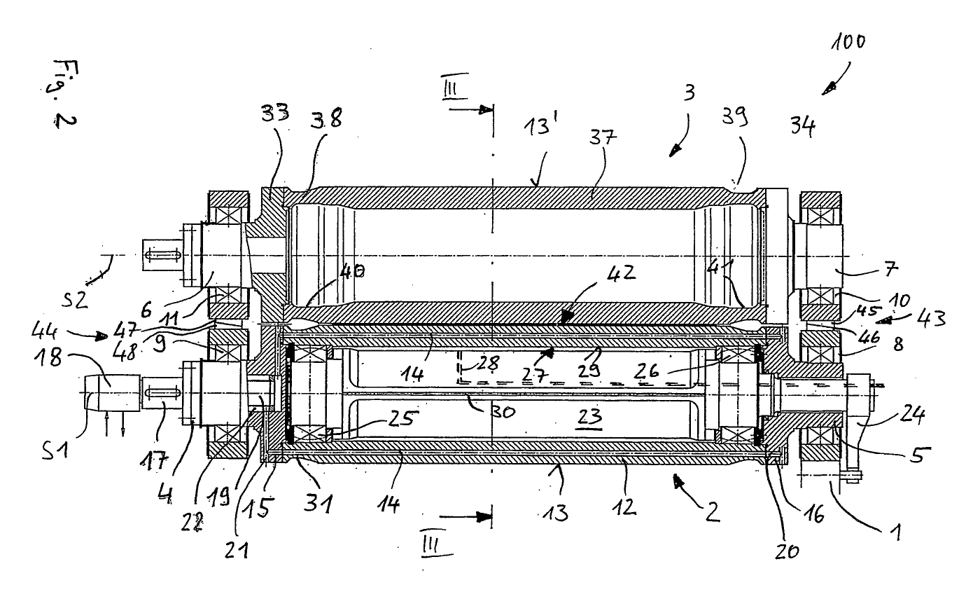

The calender unit designated as a whole by 100 in the drawings includes a machine frame 1, that is only indicated in FIG. 2, in which two rollers 2, 3 are rotatably supported by their neck of the roll 4, 5 and 6, 7, each at two support locations 8, 9 and 10, 11 about roller axes F1, F2. The support is given by roller bearings.

Roller 2, shown at the lower part of the drawing, includes a roller body 12, which is formed as a hollow cylinder. Bores 14 are introduced into the material of roller body 12, running parallel to roller axis F1 and concentric with its working roller circumference 13, which are also designated as “peripheral bores”. Flanges 15, 16 are screwed onto roller body 12 at both end face ends, to which roller necks of roll 4, 5 are attached to form one piece.

At neck of roll 15 illustrated at the left of FIG. 2, a mounting between points 17 is flange-connected for mounting a drive device via which the roll can be set into rotation, using a rotational drive. Furthermore, bordering on mounting between points 17, a connecting head 18 is provided for the supply and removal of the heat exchange medium.

The heat carrier medium supplied via connecting head 18 first extends through a central supply channel 19, provided in neck of roll 4, from where on it is supplied to every second of peripheral bores 14 via channels provided radially in flange 15. The heat carrier medium flows through these bores up to recesses 20 provided in flange 16, via which it is guided to an adjacent bore, respectively. Via this adjacent bore, as is illustrated at the bottom of FIG. 2, the heat carrier medium reaches a removal channel 21 that, in turn, extends radially into flange 15, from which it gets into an annular space 22 and to connecting head 18.

Therefore, the cooling takes place in the so-called “duo-pass system”, in which the supply and removal of the heat carrier medium always takes place in adjacent bores. Since the heat exchange medium, that is cool at first, increasingly heats up during the passage through bore 14, a more strongly and a less strongly cooled bore are next to each other, based on the duo-pass system, on the side of flange 15, whereas the adjacent bores on the side of flange 20 are cooled by approximately the same amount. The temperature differences on the side of flange 15 compensate to the extent that flange 15 is cooled in about the same manner, and thus has approximately the same temperature, as flange 16, so that thermally induced gap width errors are negligible.

At the opposite end to connecting head 18, a crosshead 23 protrudes from flange 16 and is connected via a torque support 24 to machine frame 1. Crosshead 23, which substantially fills the hollow space in roller body 12, is rotatably supported via swivel-joint roller bearings 25, 26 at a distance from bearing points 8, 9 within roller jacket 12, so that, as a result, the roller jacket is able to rotate about the carrier. At crosshead 23, an upper pressure chamber 27 is provided into which a pressure medium can be supplied that is under hydraulic pressure, via a channel 28 that is indicated by dashed lines.

Upper pressure chamber 27 is sealed off, using a sealing device 30 acting between crosshead 23 and inner circumference 29 of roller jacket 12 such that the hydraulic pressure acts only on the part of roller body 12 that is the upper part in the Figure.

In order to be able to further compensate for profile errors, such as appear based on edge effects and based on the displacement of swivel-joint roller bearings 25, 26 with respect to bearing points 8, 9, roller jacket 12 of roller 2 is arranged reduced in diameter at end regions 31, 32.

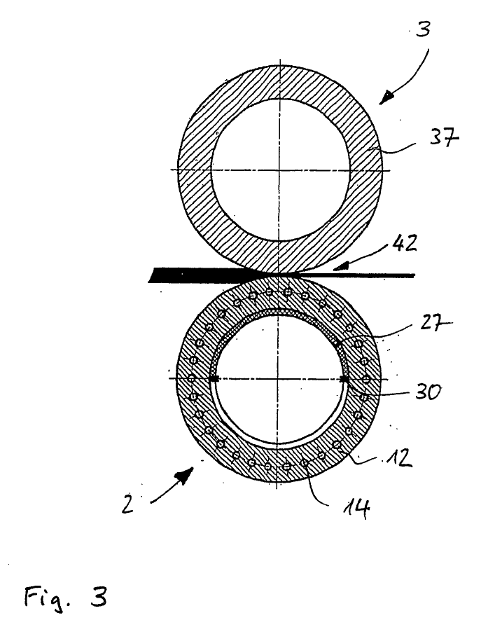

For the same purpose, roller 3, illustrated at the top in FIGS. 2 and 3, which is made up substantially of two flanges 33, 34 to which necks of roll 6, 7 are attached and a hollow-cylinder roller body 37, has end regions 38, 39 that are reduced in diameter. In addition, inner end regions 40, 41 of roller body 37 are arranged widened in diameter, in order thus to increase the resilience of roller body 37 in these regions by correction of the bending line error.

The width of roller gap 42 formed between the two rollers 2, 3 can be adjusted by length adjusters 43, 44, acting perpendicular to roller axes S1, S2, which are provided between the bearing points of the two rollers. The longitudinal adjusters in each case have two wedge elements 45, 46 and 47, 48, respectively, which are shiftable with respect to one another. From this “gap width control” one can go over in a simple manner to a “pressure control”, in which the pressure prevailing in the roller gap is controlled, and in which the wedge elements are put out of action.

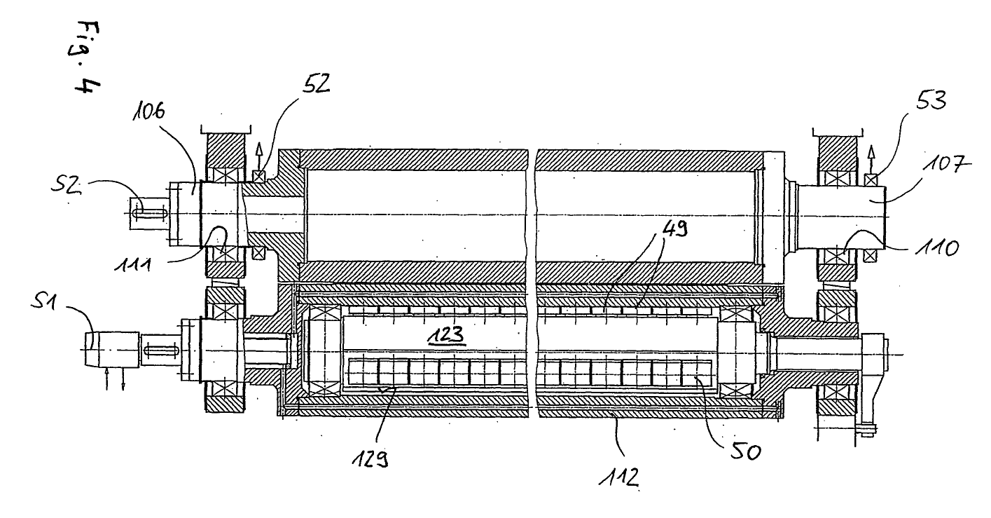

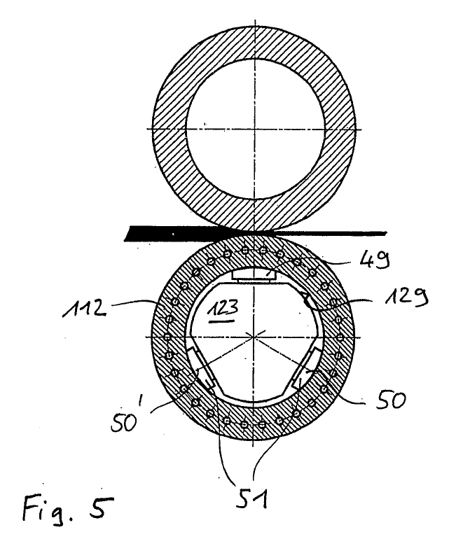

The roller pair of an exemplary embodiment of a calender unit is illustrated in FIGS. 4 and 5. In the following section, in order to avoid repetition, the differences from the above-described example embodiment are described below.

In the case of roller 102, illustrated at the bottom of FIGS. 4 and 5, crosshead 123 carries a series of hydraulic support elements 49 that act on the inside circumference 129 of roller body 112, in the working plane of the roller gap, from the inside, and the support elements are optionally able to have different pressures applied to them, as is described in European Published Patent Application No. 0 772 715, and which is therefore not described here in greater detail. In this context, in many cases it can be sufficient to make available two different pressures. Then, those support elements 49 have higher pressures applied to them which act on roller body 112 in the regions in which the film has a greater thickness than desired, after production and/or processing.

Furthermore, crosshead 123 carries two rows 50, 50′ of backwards-directed support elements 51, situated at an angle of 55° in each case to the working plane E of roller gap 142, which can also be used for correcting profile errors, in a manner described in European Published Patent Application No. 0 772 715, by the application of different pressures.

In addition, at necks of roller 106, 107 of the roller illustrated at the top in FIGS. 4 and 5, outside bearing points 110, 111, devices 52, 53 are provided for initiating forces extending transversely to roller axis S2. These may be used, on the one hand, for suppressing play in the bearings of upper roller 103, which can occur if the reaction forces, acting upon the upper roller because of the processing forces in the roller gap, are approximately the force of the weight of the roller, and, on the other hand, are used to correct profile errors, since moments can be introduced into the roller body. The different arrangements of devices 52, 53, that are illustrated at the right and the left in FIG. 4, are used alternatively. In other words, either the positioning illustrated on the left or the right is provided.

Furthermore, it is possible to insert appropriate device(s) at the lower roller, in addition or alternatively, which then are not used for the suppression of bearing play. The devices bring about a similar bending line correction as does the one in a conventional roll-bending system.

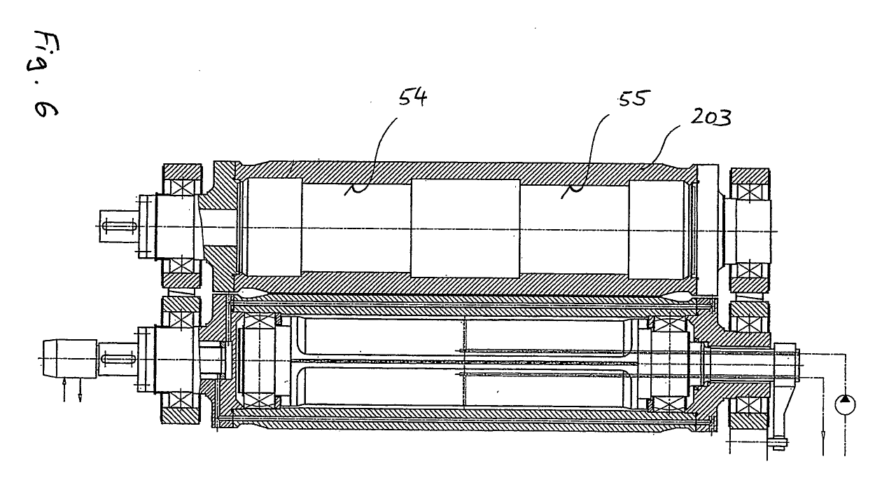

In the exemplary embodiment illustrated in FIG. 6, roller body 203 is arranged reinforced from the inside in those regions 54, 55 in which greater thicknesses of the film are to be expected, based on the bending line error.

It is understood that the preceding alternative measures named, for the reduction of profile errors, can also be implemented cumulatively or in other combinations.

Moreover, vario elements, that may be conventional, can be provided in a pressure chamber, and they reduce the hydraulic pressure acting on the roller body from the inside at the places provided for this.

### LIST OF REFERENCE NUMERALS

100 calender unit
1 machine frame
2, 3 rollers
4, 5 neck of a roller
6, 7 neck of a roller
8, 9 bearing points
10, 11 bearing points
12 roller body
13 roller circumference
14 bores
15, 16 flange
17 mounting between points
18 connecting head
19 supply channel
20 recesses
21 removal channel
22 annular space
23 crosshead
24 torque support
25, 26 swivel-joint roller bearing
27 pressure chamber
28 channel
29 inner circumference
30 sealing device
31, 32 end regions
33, 34 flange
37 roller body
38, 39 end regions
40, 41 regions
42 roller gap
43, 44 longitudinal adjuster
44, 45 wedge elements
47, 48 wedge elements
49 hydraulic support elements
50, 50′ rows
51 support elements
52, 53 devices
54, 55 regions
102 roller
106, 107 neck of a roller
110, 111 bearing points
112 roller body
123 crosshead
129 inner circumference
203 rollers
S1, S2 roller axes

1-18. (canceled)

19. A calender unit for at least one of (a) producing and (b) processing thin films, comprising:
a frame;
two rollers supported rotatably at two bearing points in the frame, each roller including a hollow cylindrical roller body that forms a working roller circumference, the two roller circumferences forming a roller gap therebetween, at least one roller coolable by a heat exchange medium, the coolable roller arranged as a hollow cylinder and including a carrier that protrudes at one end from the roller body and that is supported torsionally fixed on the frame and in the roller body to permit a rotation of the roller body about a roller axis, the carrier supported in the roller body between the two bearing points as viewed in a longitudinal direction; and
a device configured to reduce profile errors that occur in operation of the calender unit.

20. The calender unit according to claim 19, further comprising a connection device configured to supply and remove the heat exchange medium arranged at an end region of the coolable roller opposite to an end at which the carrier protrudes from the roller body.

21. The calender unit according to claim 19, the device configured to reduce the profile error includes at least one pressure chamber provided at the carrier, into which a pressure medium is introduceable, which is configured to act, in accordance with at least one force component, in an effective plane subtended by the roller axes, towards the roller gap from an inside on the roller body.

22. The calender unit according to claim 21, further comprising a device provided in the pressure chamber configured to vary a pressure in a direction of the roller axis.

23. The calender unit according to claim 19, wherein the device configured to reduce the profile error includes a plurality of hydraulic support elements arranged in the longitudinal direction of the roller and configured to act on an inner circumference of the roller body.

24. The calender unit according to claim 23, further comprising a hydraulics source configured to apply two different pressures to the support elements.

25. The calender unit according to claim 19, wherein at least one roller includes two devices configured to correct a bending line error and to act at least one of (a) thermally and (b) mechanically on edge regions of the roller body.

26. The calender unit according to claim 19, wherein the device configured to reduce the profile error is configured to reduce the profile error in accordance with forces that act transversely to the roller axis and to introduce the forces that act transversely to the roller axis into at least one neck of a roll of at least one of the rollers outside the bearing points.

27. The calender unit according to claim 19, wherein at least the coolable roller includes peripheral bores configured to pass the heat exchange medium.

28. The calender unit according to claim 19, wherein at least the roller body of the coolable roller is arranged in several parts such that the carrier is selectively removable from the roller body.

29. The calender unit according to claim 19, wherein at least one of the rollers includes a corrective grinding for reduction of the profile error.

30. The calender unit according to claim 19, a resilience of the other roller is adapted to a bending line curve of the coolable roller.

31. The calender unit according to claim 19, wherein the roller body has a varying wall thickness over a length of the roller body.

32. The calender unit according to claim 19, wherein at least the roller circumference of the roller body is hardened.

33. The calender unit according to claim 19, wherein the roller circumference is chrome plated.

34. The calender unit according to claim 19, further comprising a device configured to set the roller gap.

35. The calender unit according to claim 34, wherein the device configured to set the roller gap includes longitudinal adjusters configured to act between support locations of the rollers.

36. The calender unit according to claim 35, wherein each longitudinal adjuster includes at least two wedge elements, at least one wedge element displaceable transversely to the roller axes.
